(19) United States
(12) Patent Application Publication
(10) Pub. No.: US 2010/0095211 A1
(43) Pub. Date: Apr. 15, 2010

(54) Method and System for Annotative Multimedia

(76) Inventors: Seth Kenvin, San Francisco, CA (US); Neal Clark, San Francisco, CA (US); Jeremy Gailor, San Francisco, CA (US); Michael Dungan, San Francisco, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/562,102

(22) Filed: Sep. 17, 2009

Related U.S. Application Data
(60) Provisional application No. 61/097,641, filed on Sep. 17, 2008.

(51) Int. Cl. G06F 3/01

(52) U.S. Cl. 715/723

(57) ABSTRACT

A method and system for annotative multimedia are disclosed. According to one embodiment, a computer implemented method comprises receiving a video file from a client. A start time is received from the client. A comment is received from the client. The comment and the start time are stored, and the comment is displayed at the start time upon subsequent playback of the video file.

The present application claims the benefit of and priority to U.S. Provisional Patent Application No. 61/097,641 entitled “A Method and System for an Annotative Multimedia Player” filed on Sep. 17, 2008, and is hereby, incorporated by reference.

### FIELD

The present system relates in general to computer applications and, more specifically, to a system and method for annotative multimedia.

### BACKGROUND

As with most any content development projects, video production has stages during which assembling feedback from multiple parties is necessary in order to harvest assembled areas of expertise to guide further refinement of the content through editing and post production. Such areas of expertise could include subject matter, aesthetic merit and persuasiveness of communication.

Conventional methodologies for commenting on video footage are largely ad hoc. People receive video content by various methods including acceptance of physical disc or tape media, download by email or FTP, or viewing from a streaming site. The method of content receipt tends not to be integrated with any mechanism for feedback. People typically use generally popular communications methods such as email.

When a group consensus is sought to guide edit and post production decisions, the conventional methods used can be compromising. Some members of a group may convey reactions to a singular point person for the project while others broadcast their reactions to the entire group and still others communicate with a subset. When such communications are received, someone may respond in turn by replying to all recipients or just the originator. The combination of incremental communication and selective distribution can compromise determination of a clear consensus of the group. Someone with particularly strong authority or expertise on an issue under consideration may not be given sufficient opportunity to determine direction. This can be caused by the person not being part of relevant communication or ambiguity as to which of many messages on a consideration represents the direction being pursued.

There are other factors in communicating about video that can be exacerbating with conventional communications methods. One is clear synchronization of comment to content. There may be several files with related footage, each of which may have long durations and many elements on-screen simultaneously. With unstructured communications about content, parties are often undisciplined or inaccurate about specifying what particular video content is being referred to and what specific moments are within the content. Even with best efforts, such problems can be encountered for example when a reviewer watches video in a player that presents the relevant time codes in a manner that does not completely synchronize with someone who is receiving those comments and viewing the video in a different application on an edit station. Another area of common confusion is specifically where within a frame a reviewer is referencing when such frame is particularly rich with content or the reviewer's point is a nuanced one.

Some video editing environments do provide mechanisms for flagging content with messages for later access by whoever's performing editing and post production, although these environments can only be accessed from systems on which they are installed. They are therefore typically accessible to and usable by technical specialists in editing and post production as opposed the broader group of constituents who may be involved in a video project.

The need for better, broader communications about in-process video content is emerging as production efforts spread beyond their traditional domains such as movies, television and commercials. General organizational video production by corporations and institutions is on the rise toward a number of purposes including promotion, training, support and others. Factors in this rise include less expensive digital video equipment, more ubiquitous production talent, faster Internet speeds to transport video at higher quality levels to recipients, more ubiquitous video sharing sites and methods to avail content, and proliferation of user access to video on multiple types of devices including televisions, computers and mobile phones which make viewers more accessible. As video production efforts grow and broaden there is greater frequency of lay people who are sporadically involved in projects. In such scenarios the importance is heightened to provide easy, consistent and organized mechanisms for accessing and communicating about content towards consensus-driven editing and post production efforts.

### SUMMARY

A method and system for annotative multimedia are disclosed. According to one embodiment, a computer implemented method comprises receiving a video file from a client. A start time is received from the client. A comment is received from the client. The comment and the start time are stored, and the comment is displayed at the start time upon subsequent playback of the video file.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

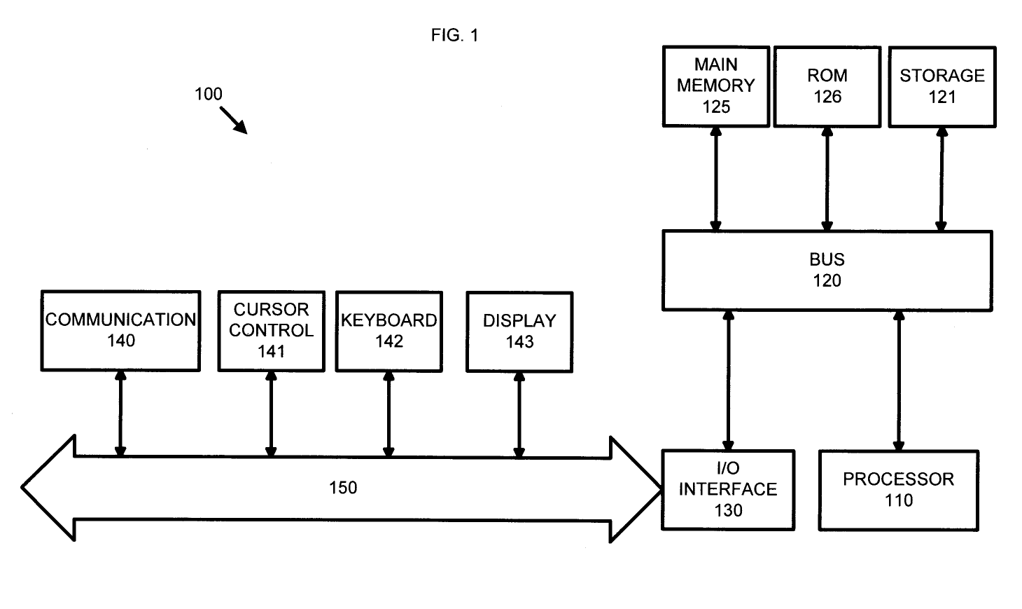

FIG. 1 illustrates an exemplary computer architecture for use with the present system, according to one embodiment.

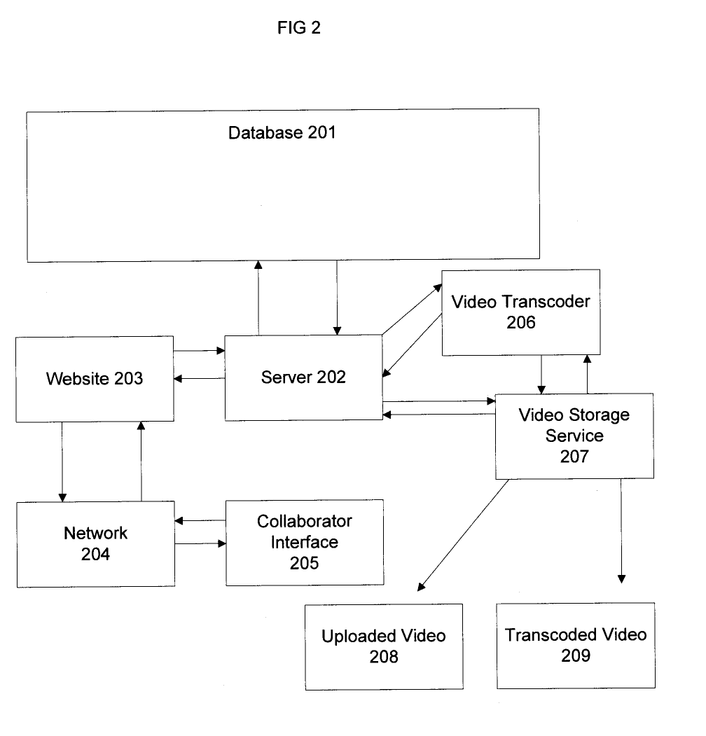

FIG. 2 is an exemplary system level diagram of a system for annotative multimedia, according to one embodiment.

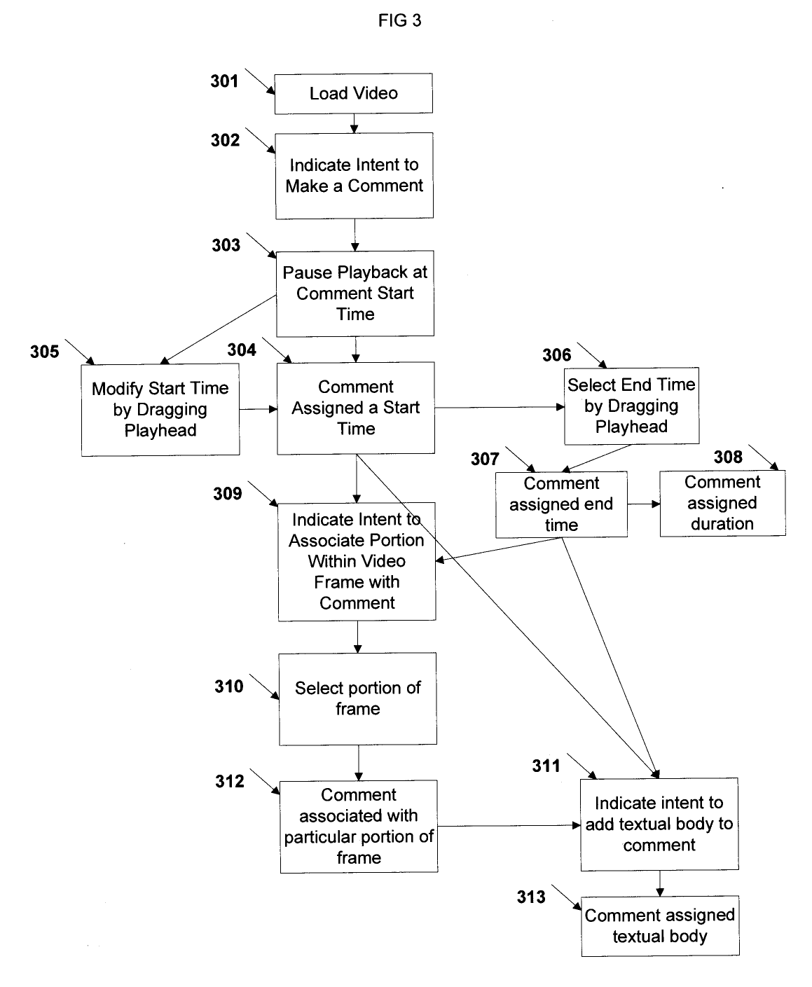

FIG. 3 illustrates an exemplary comment entering process within a system for annotative multimedia, according to one embodiment.

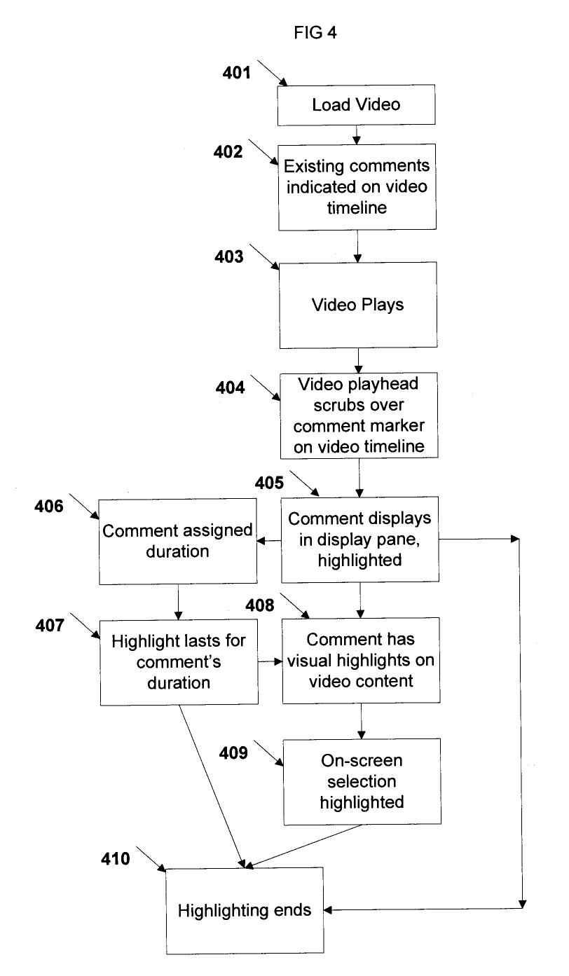

FIG. 4 illustrates an exemplary comment viewing process within a system for annotative multimedia, according to one embodiment.

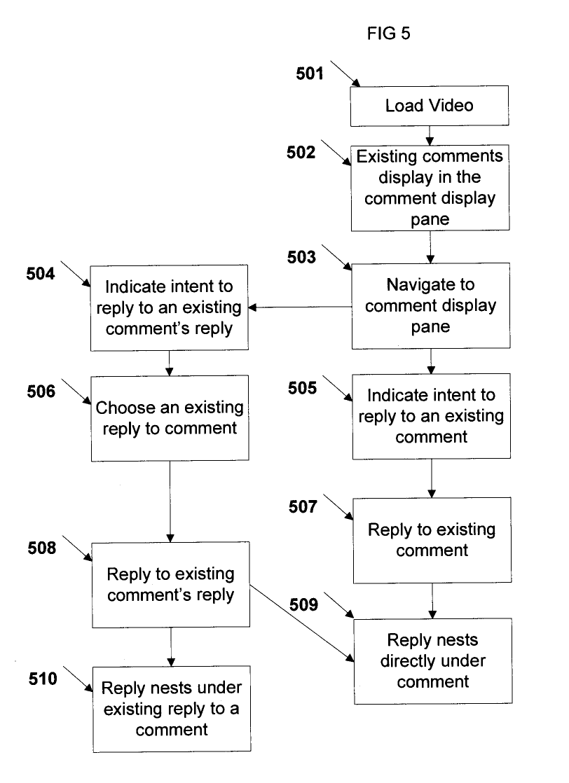

FIG. 5 illustrates an exemplary process for replying to comments and participating in threaded discussions within a system for annotative multimedia, according to one embodiment.

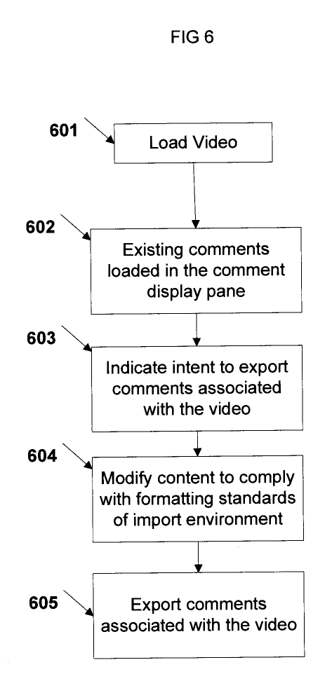

FIG. 6 illustrates an exemplary comment exporting process within a system for annotative multimedia, according to one embodiment.

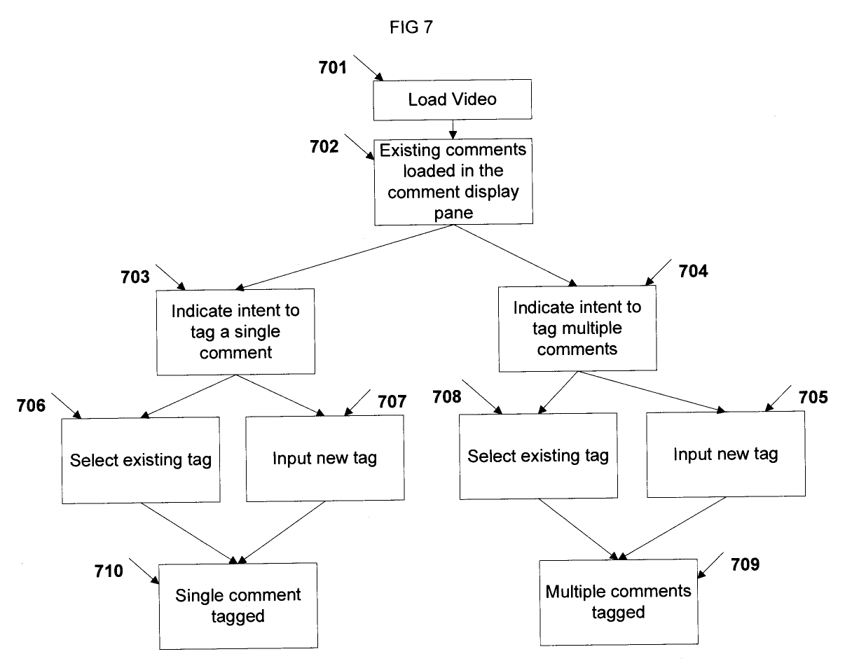

FIG. 7 illustrates an exemplary process for applying tags within a system for annotative multimedia, according to one embodiment.

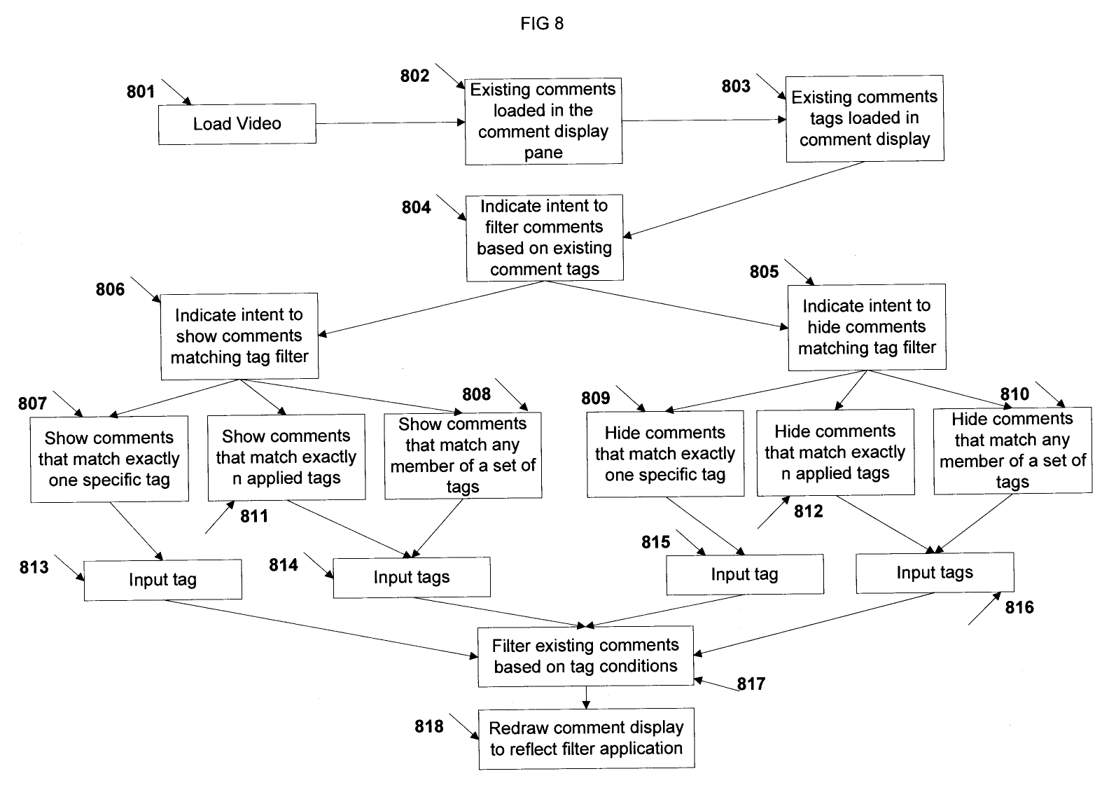

FIG. 8 illustrates an exemplary comment filtering process within a system for annotative multimedia, according to one embodiment.

### DETAILED DESCRIPTION

A method and system for annotative multimedia are disclosed. According to one embodiment, a computer implemented method comprises receiving a video file from a client. A start time is received from the client. A comment is received from the client. The comment and the start time are stored, and the comment is displayed at the start time upon subsequent playback of the video file.

The present system and method shares video footage that is in-process of editing and post production, openly assembles reactions from multiple parties including allowance of conversations, determines consensus, and filters relevant messages out from all of those assembled in order to pass on as edit instructions. The present system can be utilized to distill multiple parties' reactions to video content with efficiency and without ambiguity.

The present system provides a method to unify the modalities of communication about video footage being mutually reviewed, between multiple parties engaged in in-process editing and post production of video projects.

The present system further provides a method for streamlining collaboration during in-process editing and post production on video projects by formalizing the constituent activities involved in in-process editing and post production; providing centralized locus for workflow execution; and providing mechanisms for rapid, precise feedback regarding the video project in its various stages of execution.

A collaborator is any person participating in the in-processes editing and post production on a video project, which could be a person who's actively editing and otherwise altering content or a more lay person who passively reviews, and considers and passes on suggestions and reactions.

According to one aspect of the present system, a method for attaching comments to videos during playback is provided for collaborators. The method comprises designating a point in time on the video timeline to start the comment, optionally designating a point in time on the video timeline to end a comment, optionally designating an area of the video content's frame to associate with the comment, and receiving and storing the textual body of the comment itself.

According to another aspect of the present system, a method for viewing existing comments associated with videos during video playback is provided for collaborators by selecting a comment through various mechanisms. Video comments are displayed in container areas on the screen designated for comment display. Mechanisms include selecting a comment's visual indicator on the video playhead, moving from comment to comment on the video timeline, or traversing it with respect to comments. These actions shift focus to the comment display area, drawing attention to the comment. An example of drawing attention is to provide a highlight. For comments with duration of n seconds, this highlight lasts for n seconds, and if a comment only has an initiation point (and thus no planned duration) the highlight flashes just long enough to be notable.

In case the comment is associated with an area within video frame, these actions also draw attention to that area of the video content. An example of drawing attention is a simple highlight overlay atop the video. For comments with duration of n seconds, this highlight lasts for n seconds, and if a comment only has an initiation point the highlight flashes just long enough to be notable.

According to another aspect of the present system, a method for display of comments during video playback is provided for collaborators. When a video is loaded, the video timeline is decorated with marker points, indicating the start time of comments that have already been made for that video. Additionally when the video is loaded, comments for that video are loaded in the container area on the screen designated for comment display. During the course of normal video playback, as the video playhead scrubs over the video time line, attention is drawn to the comment pane with respect to the comment associated with that comment marker on the video timeline. An example of this is a simple highlight of the comment. For comments with a duration of n seconds, this highlight lasts for n seconds, and if a comment only has an initiation point the highlight flashes just long enough to be notable.

According to another aspect of the present system, a method for continuing discussion based on a comment is provided through the mechanisms of replies and threaded discussion rooted under a comment. These mechanisms include selecting a comment and replying to it, selecting a particular reply and replying to it, selecting a particular reply nested n levels beneath a comment and replying to it in typical threaded-discussion fashion. This allows collaborators to engage each other with respect to a particular aspect of the in-process editing and post production of a video project.

According to another aspect of the present system, a method for exporting comments is provided for collaborators including selecting a video, interacting with an interface element that triggers an export-comment action, and viewing or downloading the exported set of comments. The exported format may vary based on implementation. Exported comments could in turn be imported into video editing systems or other software relevant to the video content being considered. The content of the comment export is the amalgamation of the textual body of each comment and its associated metadata.

The export may include comments from either the whole video or a portion thereof. An example set of comment metadata may contain the following: the start time of the comment; the end time of the comment if present; the dimensions and location of the area of the video frame associated with the comment if present; the set or replies to the comment if present; the author of the comment; the timestamp of the comment's creation; a set of tags associated with the comment. This allows collaborators to share feedback and discussions in various formats, either dependent on or independent from particular software tools.

According to another aspect of the present system, a method for tagging comments is provided for collaborators including selecting a comment and interacting with an interface element that allows collaborators to input tags. A tag is a string of characters that is stored as metadata to the comment. This allows collaborators to attach notes and categories to comments for subsequent information gathering and filtering. Any single tag could be applied across multiple comments including individual replies, and any comment or individual replies could have any number of associated tags, including zero.

According to another aspect of the present system, a method for filtering the display of comments is provided for collaborators including selecting a video, configuring a filter, and applying the filter to the video's comments. The configuration of the filter can take various forms. For example, a filter may be a simple search term used for an inclusive or exclusive search, where the resulting comment display either shows or hides comments whose textual body and/or metadata match the search term. Filters may also be configured based on tag metadata. Examples of this include but are not limited to: selecting comments that match a single tag, selecting comments that match a set of multiple tags, and selecting comments that match any one of a set of multiple tags. In these cases, the resulting comment display either shows or hides comments meeting the filter criteria.

Filters can be applied to the comments associated with the whole video or a portion thereof.

Another feature of the present system is to treat comments to a video as cue points on the video timeline. This allows any collaborator to traverse the video timeline by jumping from comment to comment, bypassing any portion of the video for which there are no associated comments.

Exemplary data structure elements for comments include, but are not limited to, the following:

ID: A unique identifier of the particular comment.

Content: The written content of a comment.

Start-time: Indicates the time (ex: in #min, #sec) at which the comment starts, which is also the only time pertinent to the comment if there is no end time.

End-time: Indicates the time when the comment ends and is provided for those comments that have a duration.

Duration: The time from start-time until end time, which is zero when end-time=start-time, or there is no end-time.

Position: X, Y location (ex: pixel positioning) of a particular corner (ex: upper-left) of on screen highlight area corresponding to a comment.

Width: Length (ex: in pixels) from left-to-right of the highlight area.

Height: Length (ex: in pixels) from top-to-bottom of the highlight area.

Commenter: User identity of collaborator who left comment.

Tags: A serial list of each tag that applies to particular comment.

Reply indicator: Indicates another comment to which particular comment is a reply with value of the parent comment's ID.

Overlay data: compressed data representing a drawing that was entered by a collaborator over the video frame.

Timestamp: time the collaborator entered the comment.

Attachment: a comment can have a file attached to it, or come in the form of a file attachment, drawing, or voice recording.

The present system provides collaborators with methods to execute the workflow loop of shooting, editing, reviewing and revising more efficiently.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 is an exemplary system level diagram of a system for annotative multimedia, according to one embodiment. A database 201 is in communication with a server 202. The server 202 hosts a website 202 and the website 202 is accessible over a network 204 (enterprise, or the internet, for example). A client transmits data to and receives data from the server 202 over the network 204 using a collaborator user interface 205. The server 202 communicates with a video transcoder 206 and a video storage service 207. The video storage service 207 and the video transcoder 206 also communicate with each other. The video storage service 207 delivers uploaded video 208 and transcoded video 209. A client, using a collaborator interface 205, uploads a file (for example, a video 208) to the web application server 202 and the file is stored using the video storage service 207. The video transcoder 206 converts the file into a format appropriate (transcoded video 209) for display on the website 203.

FIG. 3 illustrates an exemplary comment entering process within a system for annotative multimedia, according to one embodiment.

A video is loaded into an annotative player interface 301 and a user indicates intent to make a comment 302. As an example, the user may click a link labeled ‘Add a comment’, or click into a text entry area designated for comment writing.

The video pauses in the interface at the moment in playback that the user indicated their intent to comment 303. The user may modify the start time by dragging a playhead (display of video progress) in the interface 305, and the comment is assigned a start time accordingly 304. For example, if the playhead is 30 seconds into the video, the comment data structure is assigned a start time of 30 seconds.

The user can optionally indicate a mark-out point on the video timeline, which indicates an end time for the comment 306, 307. Similarly to the start time, the comment data structure is assigned an end time. In this case, the comment is associated with a duration 308 of the video between the start and end point, the duration is also stored in the comment data structure. Otherwise without an end time for the comment, the comment is simply associated with a discrete moment in the video (such as the start time).

The user can optionally attach a visual highlight to the comments. The user indicates an area of the video frame to associate with the comment 309, 310, 312. According to one embodiment, the user draws a rectangle on top of the paused video by clicking in one spot, and dragging along the x and y axis. Alternative embodiments include more amorphous highlight areas, overlay shapes, and call-out text pointing to particular locations within the frame. The upper left coordinate (x,y) of the selection drawn over the paused video is stored in the comment data structure, as well as the width and height of the selection.

According to one embodiment, the user draws on the video frame and the drawing is saved as a comment data structure to be displayed appropriately when the video plays back.

The user can optionally add a textual body to the comment 311, 313. The text of the comment is also stored with the comment data structure.

Before indicating intent to save, the user can abandon the comment in which case all associated data (textual body) and metadata (start time, end time, x-y area of video content) are deleted.

FIG. 4 illustrates an exemplary comment viewing process within a system for annotative multimedia, according to one embodiment. A video is loaded by a user into an annotative player interface 401 and existing comments to the video are loaded synchronously or asynchronously with the video. When the video is loaded, the video player makes a request to the server for any comments data associated with the video. The textual body of all comments are returned to the player and appear in a container area on the screen designated for comment display, with scrolling capability.

Existing comments are visually indicated with markers on the video timeline 402. The markers are visible when the video loads, and are positioned according to the comments' start times on the video playhead. Given a one minute long video with a comment 30 seconds from the start, a comment indicator appears in the middle of the video timeline. As the video plays 403, the video playhead moves towards the comment indicator for the first 30 seconds of playback, and away from it for the second 30 seconds of playback (according to the example video mentioned).

Comments with end times are associated with a duration, which begins at the comment's start time, and ends at the comment's end time. The initial view on the video timeline for comments with durations is identical to that of comments that do not have durations.

The video playhead intersects with existing comment markers on the video timeline 404 and the comment associated with each marker is highlighted in the area on the screen designated for comment display 405.

When the video playhead scrubs over an existing comment marker on the video timeline and the associated comment has a duration 406, the comment associated with that marker is highlighted as is the area in the frame designated for comment display. In addition, the duration is visually indicated on the video timeline. According to one embodiment, once the video playhead reaches the comment marker, the portion of the video timeline corresponding to the comment's duration is highlighted. As an example, a video is one minute long with a comment 30 seconds from the start and a duration of 15 seconds. In the example, the video timeline between the 30 second and 45 second mark in video playback is highlighted. The video playhead scrubs over the highlighted portion of the video timeline, and the highlight disappears from the video timeline when the playhead reaches the end of the comment's duration—in this case, 45 seconds into playback.

If the comment is associated with a visual highlight 408, that is revealed in the display as the playhead scrubs over the comment marker in the video timeline. According to one embodiment, an overlay is placed on top of the video content, highlighting the area associated with the visual highlight.

For comments having durations 406 (a start and end time), the visual highlight is displayed for the length of the comment duration 407, 409, 410.

Video playback may be driven by existing comments by interacting with an element of the visual interface that moves the video playhead from comment marker to comment marker on the video timeline. According to one embodiment the user clicks on either the right or left side of an interface item to indicate intent to move the video playhead backward to the next comment behind its current position, or forward to move the video playhead to the next comment in front of it's current position.

FIG. 5 illustrates exemplary process flows for replying to comments and participating in threaded discussions within a system for annotative multimedia, according to one embodiment. A user loads a video using an annotative interface 501. The video player makes a request to the server for any stored comments associated with the video. Existing comments to the video are returned and loaded synchronously or asynchronously with the video. The textual body of each comment appears in a container area on the screen designated for comment display 502.

The user navigates to an area on the screen designated for comment display 503 and indicates intent to reply to a comment 505. According to one embodiment, the user clicks a link displayed underneath the comment's textual body labeled ‘reply’, which would in turn reveal a text area for the user to key in a reply. A reply consists of a textual body, and is attached to the comment that was chosen in the interface in the manner described above 507, 509.

The user may choose to reply to a reply, instead of to a comment 504, 508, 509, 510. These processes allow multi-level, threaded discussions to unfold under each video comment. Replies to comments and replies to replies are stored in memory as comments with an indication that it is a child of another comment.

FIG. 6 illustrates an exemplary comment exporting process within a system for annotative multimedia, according to one embodiment. A user loads a video using an annotative interface 601. Existing comments to the video are loaded synchronously or asynchronously with the video. The textual body of each comment appears in a container area on the screen designated for comment display 602.

The user indicates, via the interface, an intent to export comments 603. According to one embodiment, the user clicks a button on the player that triggers the comment export action. Comments for the entire video are exported to a list 605. Each element in the list represents one comment. Each element displays the comment's textual body and start time. Each element also displays the optional data that may be associated with a comment. This can include the comment's end time, visual highlight, and various other attributes of the comment's creation context, for example, the commenter's name, or the date and time the comment was created. Exported data is converted and formatted for the best subsequent import into an alternative system such as a video editing environment 604.

FIG. 7 illustrates an exemplary process for applying tags within a system for annotative multimedia, according to one embodiment. A user loads a video using an annotative interface 701. Existing comments to the video are loaded synchronously or asynchronously with the video. The textual body of each comment appears in a container area on the screen designated for comment display 702.

The user indicates an intent to associate a tag with a comment by selecting either a single comment 703 or a group of comments 704. According to one embodiment, the user selects a single comment by clicking its textual body. The user selects a single comment or a group of comments by clicking on check boxes displayed inline with the comment's textual body.

The user applies a tag to a comment 710 or group of comments 709 by keying in the value of the tag after choosing a comment or group of comments in the manner described above. The user can either select an existing tag to apply (706, 708) or input a new tag to apply (707, 705).

FIG. 8 illustrates an exemplary comment filtering process within a system for annotative multimedia, according to one embodiment. A user loads a video using an annotative interface 801. Existing comments and tags to the video are loaded synchronously or asynchronously with the video. The textual body of comments and comment tags appear in a container area on the screen designated for comment display 802, 803.

The user indicates an intent to filter the comment display based on existing comment tags 804. The user can elect to display 806 or hide 805 comments matching a tag filter. The user can elect to display or hide comments tagged with a single chosen tag 807, 809, comments tagged with multiple chosen tags 811, 812, or comments tagged with any one of multiple chosen tags 808, 810. The user inputs tags (813, 814, 815, 816) for filtering. According to one embodiment, the user selects a drop down menu with interface elements to configure the comment filter parameters. Comments matching the filter criteria are displayed in the container area on the screen designated for comment display 817, 818.

A method and system for annotative multimedia are disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

We claim:

1. A computer implemented method, comprising:
receiving a video file from a client;
receiving a start time from the client;
receiving a comment from the client;
storing the comment and the start time; and
displaying the comment at the start time upon subsequent playback of the video file.

2. The computer implemented method of claim 1, further comprising:
receiving an end time from the client, the end time indicating a place in the video file after the start time;
calculating a duration as a difference between the start time and the end time; and
storing the end time with the comment and the start time.

3. The computer implemented method of claim 1, further comprising:
receiving a screen selection from the client, the screen selection indicating a portion of display of the video file;
storing the screen selection with the comment and the start time; and
displaying the screen selection with the comment upon subsequent playback of the video file.

4. The computer implemented method of claim 1, wherein a comment comprises text, voice recording, a drawing, and a screen recording of the video file.

5. The computer implemented method of claim 1, further comprising:
receiving a first reply to an existing comment from the client;
storing the first reply with the comment and the start time; and
displaying the first reply with the comment upon subsequent playback of the video file.

6. The computer implemented method of claim 5, further comprising:
receiving a second reply to the first reply from the client;
storing the second reply with the first reply; and
displaying the second reply with the first reply upon subsequent playback of the video file.

7. The computer implemented method of claim 1, further comprising:
receiving a request to export comment data associated with the video file from the client;
converting the comment data; and
exporting the comment data.

8. The computer implemented method of claim 1, further comprising:
receiving a tag from the client;
storing the tag with the comment; and
displaying the tag with the comment upon subsequent playback of the video file.

9. The computer implemented method of claim 8, further comprising:
displaying tags to the client;
receiving a request from the client to filter comments associated with the video file according to one or more selected tags;
displaying resulting filtered comments upon subsequent playback of the video file.

10. A system, comprising:
a server hosting a website, the server in communication with a database;
a video storage server in communication with the server, wherein the video storage service stores videos; and
a collaborator interface residing on the website, wherein the server
receives a video file from the client;
receives a start time from the client;
receives a comment from the client;
stores the comment and the start time; and
displays the comment at the start time upon subsequent playback of the video file.

11. The system of claim 10, wherein the server further
receives an end time from the client, the end time indicating a place in the video file after the start time;
calculates a duration as a difference between the start time and the end time; and
stores the end time with the comment and the start time.

12. The system of claim 10, wherein the server further
receives a screen selection from the client, the screen selection indicating a portion of display of the video file;
stores the screen selection with the comment and the start time; and
displays the screen selection with the comment upon subsequent playback of the video file.

13. The system of claim 10, wherein a comment comprises text, voice recording, a drawing, and a screen recording of the video file.

14. The system of claim 10, wherein the server further
receives a first reply to an existing comment from the client;
stores the first reply with the comment and the start time; and
displays the first reply with the comment upon subsequent playback of the video file.

15. The system of claim 14, wherein the server further
receives a second reply to the first reply from the client;
stores the second reply with the first reply; and
displays the second reply with the first reply upon subsequent playback of the video file.

16. The system of claim 10, wherein the server further
receives a request to export comment data associated with the video file from the client;
converts the comment data; and
exports the comment data to the client.

17. The system of claim 10, wherein the server further
receives a tag from the client;
stores the tag with the comment; and
displays the tag with the comment upon subsequent playback of the video file.

18. The system of claim 17, wherein the server further
displays tags to the client;
receives a request from the client to filter comments associated with the video file according to one or more selected tags;
displays resulting filtered comments upon subsequent playback of the video file.
